(19) United States
(12) Patent Application Publication
(10) Pub. No.: US 2026/0348193 A1
(43) Pub. Date: Nov. 5, 2026

(54) LOCK DEVICE AND SYSTEM

(71) Applicant: ASSA ABLOY AB, Stockholm (SE)

(72) Inventors: Erlend Omvik, Skotbu (NO); Stig Morten Thu, Holter (NO)

(21) Appl. No.: 19/117,698

(22) PCT Filed: Sep. 27, 2023
(86) PCT No.: PCT/EP2023/076699

§ 371 Date: Apr. 2, 2025

(30) Foreign Application Priority Data
Oct. 7, 2022 (SE) 2251173-7

(51) Int. Cl. E05B 13/00

(52) U.S. Cl. CPC E05B 13/002

(57) ABSTRACT

A lock device (12) comprising a bolt (28) movable between an extended bolt position (44) and a retracted bolt position (82), the bolt having a bolt structure (60); an auxiliary member (30) movable between an extended auxiliary position (46) and a retracted auxiliary position (84), the auxiliary member having an auxiliary structure (66); a sensor (48); and a trigger member (50) movable between a deactivated position (52) where the trigger member does not cause activation of the sensor, and an activated position (86) where the trigger member causes activation of the sensor, the trigger member being forced towards the activated position; wherein the bolt structure and the auxiliary structure are arranged to allow the trigger member to move from the deactivated position to the activated position when the bolt adopts the extended bolt position and the auxiliary member adopts the retracted auxiliary position.

### TECHNICAL FIELD

The present disclosure generally relates to lock devices. In particular, a lock device for installation in an access member, and a system comprising a lock device, are provided.

### BACKGROUND

Many lock devices comprise a bolt movable between a retracted position and an extended position. One example of such lock device is a tubular latch comprising a latch bolt. The tubular latch can be integrated in a door leaf rotatable relative to a frame and the latch bolt can engage a strike opening in a frame when the door leaf is closed. For various reasons, it may be desired to detect a position of the latch bolt and a position of the door leaf. One reason may be to monitor a state of the lock device, for example to detect misuse or errors. Another reason may be that the lock device relies on a position of a movable component to trigger an electronic function.

US 2021131144 A1 discloses a latchbolt assembly comprising a latchbolt and a plunger in parallel with the latchbolt. An open/closed position of a door can be inferred based upon a projected/depressed position of the plunger. When the door is in its closed position, the plunger is retained in its depressed position due to engagement with the strike, and a magnet in the strike is in close proximity to a front end of the plunger. The plunger is formed of a magnetizable material such that a magnetic flux is transmitted along the length of the plunger. With a rear end of the of the plunger in close proximity to a magnetic sensor, this magnetic flux alters the output of the magnetic sensor.

### SUMMARY

One object of the invention is to provide an improved lock device.

A further object of the invention is to provide an improved system comprising a lock device.

These objects are achieved by the lock device according to appended claim 1 and the system according to appended claim 14.

The invention is based on the realization that by providing a lock device comprising a bolt including a bolt structure and an auxiliary member including an auxiliary structure, and where the bolt structure and the auxiliary structure only enable a trigger member to trigger a sensor when both the bolt is in an extended bolt position and when the auxiliary member is in a retracted auxiliary position, the lock device can conclude that a door leaf is closed in a frame and that the bolt is extended into a strike opening using a single sensor.

According to a first aspect, there is provided a lock device for installation in an access member, the lock device comprising a base structure; a bolt movable relative to the base structure between an extended bolt position for engagement with a strike opening of a strike and a retracted bolt position for disengagement from the strike opening, the bolt having a bolt structure; an auxiliary member movable relative to the base structure between an extended auxiliary position and a retracted auxiliary position for engagement with a strike plate of the strike, the auxiliary member having an auxiliary structure; a sensor; and a trigger member movable between a deactivated position where the trigger member does not cause activation of the sensor, and an activated position where the trigger member causes activation of the sensor, the trigger member being forced towards the activated position. The bolt structure and the auxiliary structure are arranged to allow the trigger member to move from the deactivated position to the activated position when the bolt adopts the extended bolt position and the auxiliary member adopts the retracted auxiliary position. The bolt structure is arranged to prevent the trigger member from moving from the deactivated position to the activated position when the bolt adopts the retracted bolt position. The auxiliary structure is arranged to prevent the trigger member from moving from the deactivated position to the activated position when the auxiliary member adopts the extended auxiliary position.

Since the bolt structure and the auxiliary structure are arranged to allow the trigger member to move from the deactivated position to the activated position when the bolt adopts the extended bolt position and the auxiliary member adopts the retracted auxiliary position, and since the trigger member is forced towards the activated position, the trigger member may be released to cause triggering of the sensor when, and only when, the bolt is in the extended bolt position and the auxiliary member is in the retracted auxiliary position. The lock device therefore enables determination of both a position of the bolt and a position of the auxiliary member using a single sensor. Thus, no stand-alone sensor is required only for determining that a door leaf (or other access member) is closed and in a frame, and no stand-alone sensor is required only for determining that the bolt is extended. When the bolt is in the extended bolt position and the auxiliary member is in the retracted auxiliary position, the lock device enables reliable conclusion both that the door leaf (or other access member) is closed and that the bolt is projected, e.g. based on an electrical signal from the sensor.

In comparison with US 2021131144 A1, the lock device of the first aspect enables an additional determination of a position of the bolt without adding an additional sensor. Moreover, the lock device enables elimination of a magnet in a strike, and enables the auxiliary member to be made of a wide range of different materials, including non-magnetizable materials.

When the trigger member is in the deactivated position, the sensor is in a deactivated state. Conversely, when the trigger member is in the activated position, the sensor is in an activated state.

Throughout the present disclosure, the sensor may be an electrical switch. Due to the sensor, the lock device is provided with bolt sensor functionality. The bolt may comprise a bolt head. The bolt may be a latch bolt. In this case, the lock device provides latch bolt sensor functionality.

The lock device may comprise a dead bolt in addition to the latch bolt. Alternatively, the bolt may be a dead bolt.

The auxiliary member may be an auxiliary bolt. The auxiliary member may comprise a plunger.

The lock device may be tubular. In case the bolt is a latch bolt, the lock device may be a tubular latch.

The bolt may be movable along a movement direction between the retracted bolt position and the extended bolt position. The bolt may be substantially linearly movable, or linearly movable between the retracted bolt position and the extended bolt position. Alternatively, or in addition, the auxiliary member may be substantially linearly movable, or linearly movable between the retracted auxiliary position and the extended auxiliary position.

Each of the bolt structure and the auxiliary structure may be an aperture. The bolt structure and the auxiliary structure may be aligned along the movement direction of the bolt when the bolt adopts the extended bolt position and the auxiliary member adopts the retracted auxiliary position.

The lock device may further comprise an electronic control system. The control system may comprise at least one data processing device and at least one memory having at least one computer program stored thereon, the at least one computer program comprising program code which, when executed by the at least one data processing device, causes the at least one data processing device to perform, or command performance of, various functions associated with the lock device. The lock device may be configured to handle an electrical signal from the sensor indicative of the sensor being in the activated state.

The access member may be a door leaf or a window sash. The access member may be movable relative to a frame, such as rotatable relative to the frame. The strike may be installed in the frame. When the access member is stationary, the base structure may be stationary.

The trigger member and the bolt structure may be arranged to cooperate to prevent movement of the bolt from the extended bolt position to the retracted bolt position when the trigger member is in the activated position. Thus, the trigger member can both serve to indicate that the bolt is in the extended bolt position and that the auxiliary member is in the retracted auxiliary position, as well as preventing the bolt from being retracted. The bolt structure may be configured to contact the trigger member to prevent movement of the bolt from the extended bolt position to the retracted bolt position when the trigger member is in the activated position.

The bolt structure may comprise a blocking bolt surface substantially transverse to, or transverse to, a movement direction of the bolt for being engaged by the trigger member in the activated position to prevent movement of the bolt from the extended bolt position to the retracted bolt position.

The trigger member may comprise a blocking trigger surface oriented substantially transverse to, or transverse to, the movement direction and arranged to be engaged by the blocking bolt surface when the trigger member adopts the activated position.

The bolt may comprise a bolt plate including the bolt structure and the auxiliary member may comprise an auxiliary plate including the auxiliary structure. In this case, the auxiliary plate may be substantially parallel with, or parallel with, the bolt plate. The provision of the bolt plate and the auxiliary plate enables a compact design of the lock device. The bolt structure may be provided on a relatively thin side of the bolt plate. Correspondingly, the auxiliary structure may be provided on a relatively thin side of the auxiliary plate.

The bolt structure may be an aperture in the bolt plate. Correspondingly, the auxiliary structure may be an aperture in the auxiliary plate. When the bolt is in the extended bolt position and the auxiliary member is in the retracted auxiliary position, the trigger member may be received in the apertures. For example, the trigger member may comprise a trigger edge arranged to be received in the apertures. The trigger edge may be oriented substantially transverse to, or transverse to, the movement direction of the bolt. As one alternative, the bolt structure may be a bolt edge and the auxiliary structure may be an auxiliary edge. When the bolt is in the extended bolt position and the auxiliary member is in the retracted auxiliary position, the bolt edge and the auxiliary edge may be received in a trigger aperture of the trigger member. In any case, the trigger member may be arranged to contact each of the bolt structure and the auxiliary structure. Moreover, the trigger member may be arranged to contact each of the bolt plate and the auxiliary plate.

When the bolt is not in the extended bolt position and the auxiliary member is not in the retracted auxiliary position, the trigger member may ride on the bolt plate and on the auxiliary plate outside the apertures.

A bolt head of the bolt may be locked to the bolt plate in the movement direction. A plunger of the auxiliary member may be fixed to the auxiliary plate.

The trigger member may be pivotable between the deactivated position and the activated position. The trigger member may be pivotable substantially about, or about, a pivot axis transverse to the movement direction.

The lock device may further comprise a bolt retractor. The bolt retractor may be arranged to be driven by manual actuation of an actuation member, such as a handle, and arranged such that movement of the bolt retractor causes the bolt to move from the extended bolt position to the retracted bolt position. The bolt retractor may comprise a detrigger surface. The detrigger surface may alternatively be referred to as an inactivation surface. The detrigger surface may be arranged to transmit a movement of the bolt retractor to a movement of the trigger member from the activated position to the deactivated position. To this end, the detrigger surface may for example engage the trigger edge of the trigger member.

The bolt retractor may comprise a bolt retractor plate. The bolt retractor plate may be parallel with the bolt plate and the auxiliary plate.

The auxiliary member may be movable relative to the base structure in parallel with movements of the bolt between the extended bolt position and the retracted bolt position.

The base structure may comprise a forend.

The bolt and the auxiliary member may protrude from the base structure in the extended bolt position and in the extended auxiliary position, respectively. The bolt and the auxiliary member may protrude less, or may not protrude at all, from the base structure in the retracted bolt position and in the retracted auxiliary position, respectively.

The trigger member may be arranged to contact the sensor in the activated position. Thus, the trigger member may act directly on the sensor. This contributes to a compact design of the lock device. Alternatively, the lock device may comprise one or more intermediate components such that the trigger member acts indirectly on the sensor.

The lock device may comprise at least one spring arranged to force the trigger member towards the activated position. According to one alternative, the trigger member is arranged to move from the deactivated position to the activated position by gravity.

The at least one spring may comprise a bolt spring arranged to force the bolt from the retracted bolt position to the extended bolt position. Alternatively, or in addition, the at least one spring may comprise an auxiliary spring arranged to force the auxiliary member from the retracted auxiliary position to the extended auxiliary position. By using the bolt spring and the auxiliary spring to both drive the bolt and the auxiliary member, respectively, and to drive the trigger member, the bolt spring and the auxiliary spring perform more than two functions. This enables a reduction of a number of components of the lock device and a consequentially more compact design.

The bolt and the auxiliary member may be configured such the auxiliary member is forced by the bolt from the extended auxiliary position to the retracted auxiliary position by movement of the bolt from the extended bolt position to the retracted bolt position. To this end, the bolt may comprise an auxiliary member engaging surface and the auxiliary member may comprise a bolt engageable surface parallel with, and arranged to contact, the auxiliary member engaging surface. Each of the auxiliary member engaging surface and the bolt engageable surface may be substantially transverse to, or transverse to, the movement direction of the bolt. The bolt may in the retracted bolt position be arranged to prevent movement of the auxiliary member from the retracted auxiliary position to the extended auxiliary position.

According to a second aspect, there is provided a system comprising a lock device according to the first aspect, a frame including the strike, and the access member movable relative to the frame. In this case, the lock device may be installed in the access member. The frame, the strike and the access member may be of any type described in connection with the first aspect.

### BRIEF DESCRIPTION OF THE DRAWINGS

Further details, advantages and aspects of the present disclosure will become apparent from the following description taken in conjunction with the drawings, wherein:

FIG. 1: schematically represents a front view of system comprising an access member, a lock device and a strike;

FIG. 2: schematically represents a side view of the strike;

FIG. 3: schematically represents a perspective front view of the lock device;

FIG. 4a: schematically represents a partial perspective front view of the lock device when a bolt is in an extended bolt position and an auxiliary member is in an extended auxiliary position;

FIG. 4b: schematically represents a partial perspective rear view of the lock device in FIG. 4a;

FIG. 4c: schematically represents a partial front view of the lock device in FIGS. 4a and 4b;

FIG. 4d: schematically represents a partial top view of the lock device in FIGS. 4a-4c;

FIG. 5: schematically represents a perspective front view of the bolt;

FIG. 6: schematically represents a perspective front view of the auxiliary member;

FIG. 7a: schematically represents a perspective side view of the trigger member;

FIG. 7b: schematically represents a perspective front view of the trigger member;

FIG. 8: schematically represents a partial perspective rear view of the lock device in FIGS. 4a-4d;

FIG. 9a: schematically represents a partial perspective front view of the lock device when the bolt is in a retracted bolt position and the auxiliary member is in a retracted auxiliary position;

FIG. 9b: schematically represents a partial perspective rear view of the lock device in FIG. 9a;

FIG. 9c: schematically represents a partial front view of the lock device in FIGS. 9a and 9b;

FIG. 9d: schematically represents a partial top view of the lock device in FIGS. 9a-9c;

FIG. 10a: schematically represents a partial perspective front view of the lock device when the bolt is in the extended bolt position and the auxiliary member is in the retracted auxiliary position;

FIG. 10b: schematically represents a partial perspective rear view of the lock device in FIG. 10a;

FIG. 10c: schematically represents a partial front view of the lock device in FIGS. 10a and 10b; and

FIG. 10d: schematically represents a partial top view of the lock device in FIGS. 10a-10c.

### DETAILED DESCRIPTION

In the following, a lock device for installation in an access member, and a system comprising a lock device, will be described. The same or similar reference numerals will be used to denote the same or similar structural features.

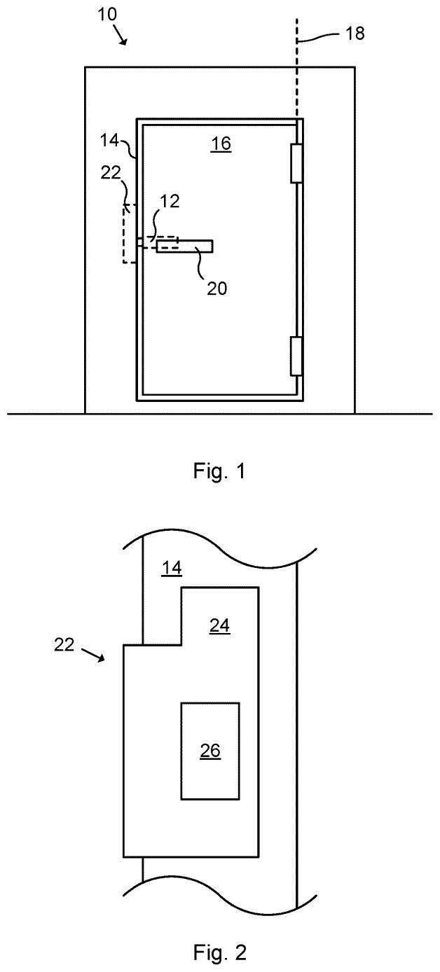

FIG. 1 schematically represents a front view of one example of a system 10. The system 10 comprises one example of a lock device 12. The system 10 of this example further comprises a frame 14 and a door leaf 16 rotatable relative to the frame 14 about a vertical door axis 18. The door leaf 16 is one example of an access member according to the present disclosure. The lock device 12 is installed in the door leaf 16. In FIG. 1, the door leaf 16 is in a closed position.

The system 10 further comprises a handle 20. The handle 20 is one example of an actuation member for manual actuation according to the present disclosure. The handle 20 is used to control the lock device 12 to open the door leaf 16.

The system 10 further comprises a strike 22. The strike 22 is installed in the frame 14.

FIG. 2 schematically represents a side view of the strike 22. As shown, the strike 22 comprises a strike plate 24 having a strike opening 26.

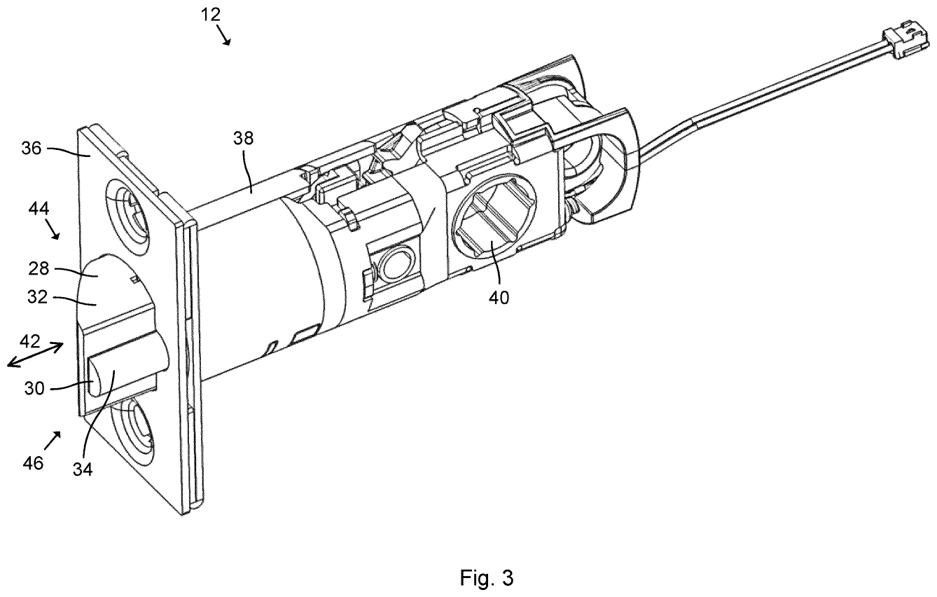

FIG. 3 schematically represents a perspective front view of the lock device 12. The lock device 12 comprises a bolt 28 and an auxiliary member 30. The bolt 28 comprises a bolt head 32. The auxiliary member 30 comprises a plunger 34.

The bolt 28 of this example is a latch bolt. The lock device 12 of this example is a tubular latch.

The lock device 12 of this example further comprises a forend 36. The forend 36 is one example of a base structure according to the present disclosure. In the closed position of the door leaf 16, the forend 36 may be parallel with the strike plate 24. Alternatively, the forend 36 may be slightly angled relative to the strike plate 24 in the closed position of the door leaf 16, such as angled at least 1° and/or less than 10°, such as 5°. In this case, the forend 36 may be angled about an axis parallel with the door axis 18.

The lock device 12 of this example further comprises a housing 38 and a follower 40. The follower 40 comprises an opening for receiving a shaft rotationally driven by the handle 20.

The bolt 28 and the auxiliary member 30 are in this example linearly movable relative to the forend 36 in a movement direction 42 and in parallel with each other. In FIG. 3, the bolt 28 is in an extended bolt position 44 and the auxiliary member 30 is in an extended auxiliary position 46. The bolt 28 is movable relative to the forend 36 between the extended bolt position 44 and a retracted bolt position. The auxiliary member 30 is movable relative to the forend 36 between the extended auxiliary position 46 and a retracted auxiliary position. As shown in FIG. 3, the bolt 28 and the auxiliary member 30 pass through, and protrude from, the forend 36 in the extended bolt position 44 and the extended auxiliary position 46, respectively.

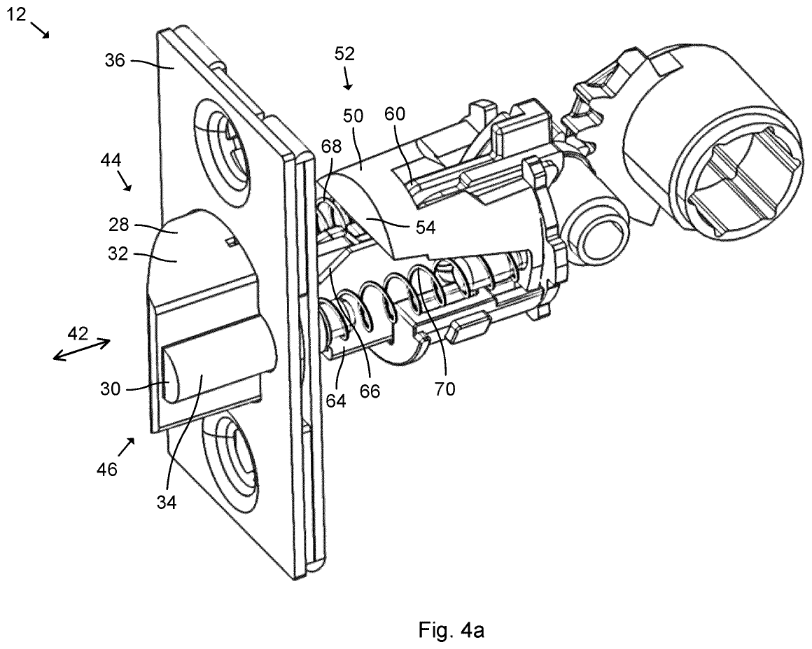

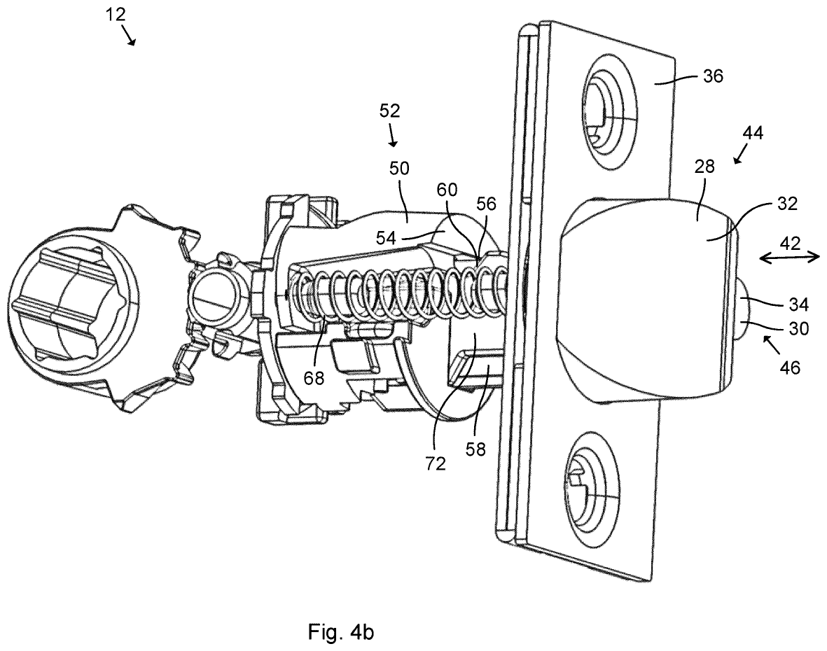

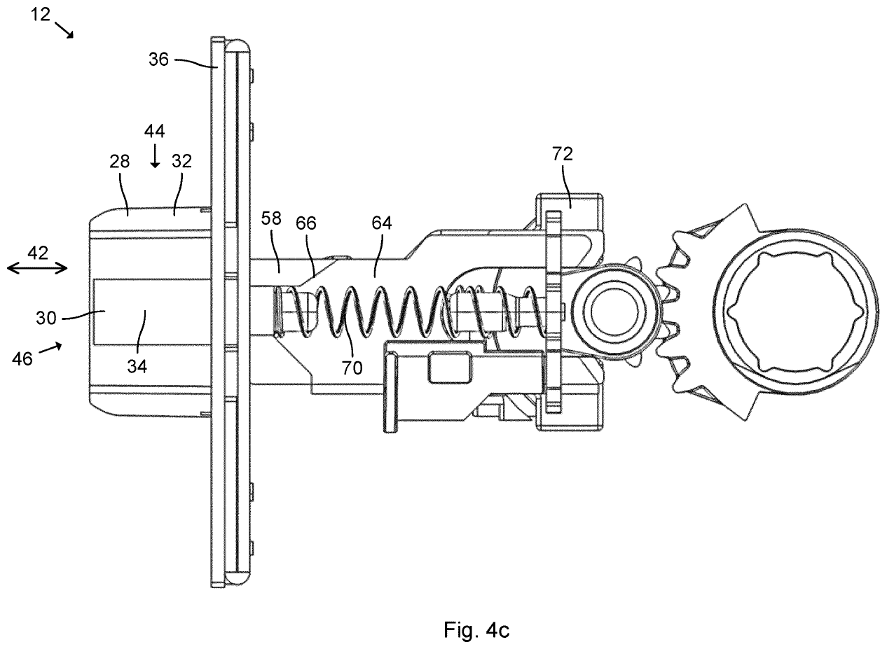

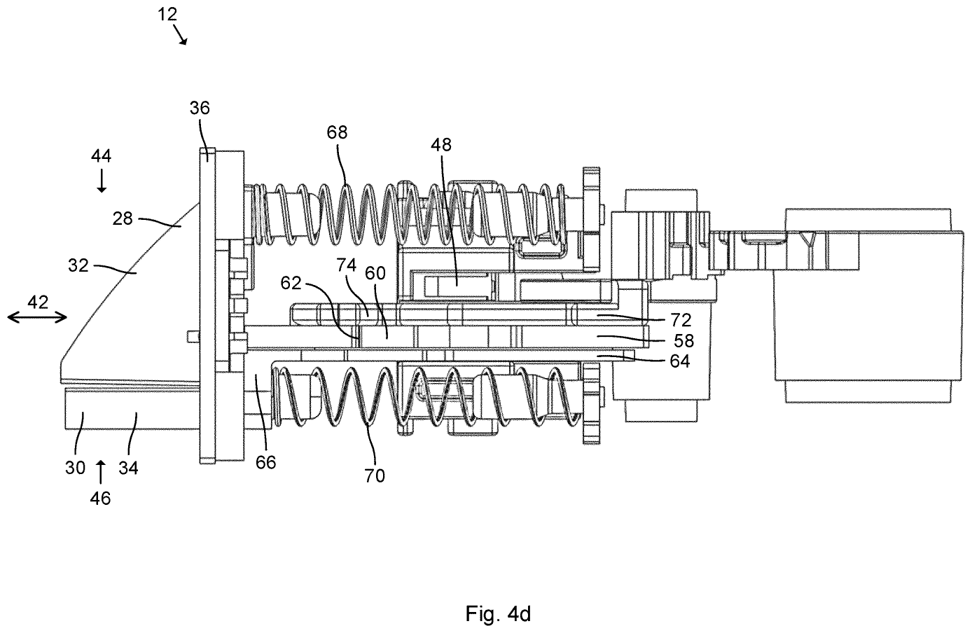

FIG. 4a schematically represents a partial perspective front view of the lock device 12 when the bolt 28 is in the extended bolt position 44 and the auxiliary member 30 is in the extended auxiliary position 46, FIG. 4b schematically represents a partial perspective rear view of the lock device 12 in FIG. 4a, FIG. 4c schematically represents a partial front view of the lock device 12 in FIGS. 4a and 4b, and FIG. 4d schematically represents a partial top view of the lock device 12 in FIGS. 4a-4c.

As shown in FIG. 4d, the lock device 12 of this example comprises an electrical switch 48. The electrical switch 48 is one example of a sensor according to the present disclosure.

As shown in FIGS. 4a and 4b, the lock device 12 further comprises a trigger member 50. Except for the removal of the trigger member 50 in FIGS. 4c and 4d, FIGS. 4a-4d show views of the lock device 12 in the same state. In FIGS. 4a-4d, the trigger member 50 is in a deactivated position 52. The trigger member 50 is movable between the deactivated position 52 and an activated position.

The trigger member 50 of this example comprises a blocking trigger surface 54. In the deactivated position 52, the blocking trigger surface 54 is oriented substantially transverse to the movement direction 42.

The trigger member 50 of this example also comprises a trigger edge 56. The trigger edge 56 is oriented transverse to the movement direction 42.

In addition to the bolt head 32, the bolt 28 of this example further comprises a bolt plate 58. The bolt plate 58 comprises a bolt structure 60. The bolt structure 60 is exemplified as an aperture in the bolt plate 58, here in an upper portion of the bolt plate 58.

The bolt plate 58 further comprises a blocking bolt surface 62. As shown in FIG. 4d, the blocking bolt surface 62 is oriented transverse to the movement direction 42.

In addition to the plunger 34, the auxiliary member 30 this example further comprises an auxiliary plate 64. The bolt plate 58 and the auxiliary plate 64 are parallel which contributes to a compact design of the lock device 12. The auxiliary plate 64 comprises an auxiliary structure 66. The auxiliary structure 66 is exemplified as an aperture in the auxiliary plate 64, here in an upper portion of the auxiliary plate 64.

The lock device 12 of this example further comprises a bolt spring 68. The bolt spring 68 exerts a force on the bolt 28 towards the extended bolt position 44. In this example, the bolt spring 68 acts between the trigger member 50 and the bolt head 32. The bolt spring 68 and the bolt plate 58 are thus arranged in parallel in this example which further contributes to a compact design of the lock device 12. The bolt spring 68 of this example is a compression coil spring.

The lock device 12 of this example further comprises an auxiliary spring 70. The auxiliary spring 70 exerts a force on the auxiliary member 30 towards the extended auxiliary position 46. In this example, the auxiliary spring 70 acts between the trigger member 50 and the plunger 34. The auxiliary spring 70 and the auxiliary plate 64 are thus arranged in parallel in this example further which further contributes to a compact design of the lock device 12. The auxiliary spring 70 of this example is a compression coil spring.

The lock device 12 of this example further comprises a bolt retractor 72. The bolt retractor 72 can be driven in the movement direction 42 by rotation of the follower 40. As particularly shown in FIGS. 4b and 4d, the bolt retractor 72 comprises a bolt retractor plate (not denoted) parallel with each of the bolt plate 58 and the auxiliary plate 64.

The bolt retractor 72 comprises a detrigger surface 74. The detrigger surface 74 is in this example arranged to cooperate with the trigger edge 56.

In the deactivated position 52, the trigger member 50 is forced towards the electrical switch 48, here by the bolt spring 68 and the auxiliary spring 70. However, since the auxiliary member 30 is in the extended auxiliary position 46, the auxiliary structure 66 is not aligned with the trigger edge 56. The trigger edge 56 is thus positioned on top of (in this example) the auxiliary plate 64 without entering the auxiliary structure 66 when the auxiliary member 30 is in the extended auxiliary position 46. Thus, as shown in FIGS. 4a-4d, the auxiliary structure 66 is arranged to prevent the trigger member 50 from moving from the deactivated position 52 to the activated position when the auxiliary member 30 adopts the extended auxiliary position 46. When the trigger member 50 is in the deactivated position 52, the trigger member 50 does not trigger the electrical switch 48.

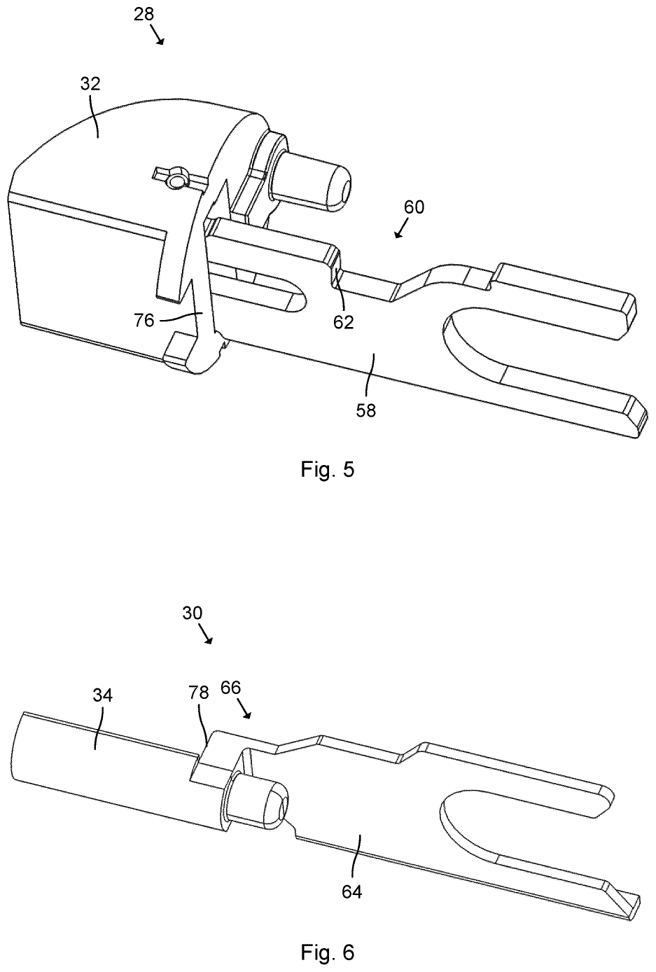

FIG. 5 schematically represents a perspective front view of the bolt 28. In FIG. 5, the bolt plate 58 having the bolt structure 60 and the blocking bolt surface 62 can be seen more clearly. In this example, the bolt head 32 is rigidly coupled to the bolt plate 58. Movements of the bolt head 32 along the movement direction 42 are transferred to movements of the bolt plate 58 along the movement direction 42.

The bolt 28 of this example further comprises an auxiliary member engaging surface 76. The auxiliary member engaging surface 76 is transverse to the movement direction 42.

FIG. 6 schematically represents a perspective front view of the auxiliary member 30. In FIG. 6, the auxiliary plate 64 having the auxiliary structure 66 can be seen more clearly. The auxiliary member 30 of this example further comprises a bolt engageable surface 78. The auxiliary member engaging surface 76 is configured to engage the bolt engageable surface 78. The bolt engageable surface 78 is transverse to the movement direction 42. The plunger 34 is here fixed to the auxiliary plate 64.

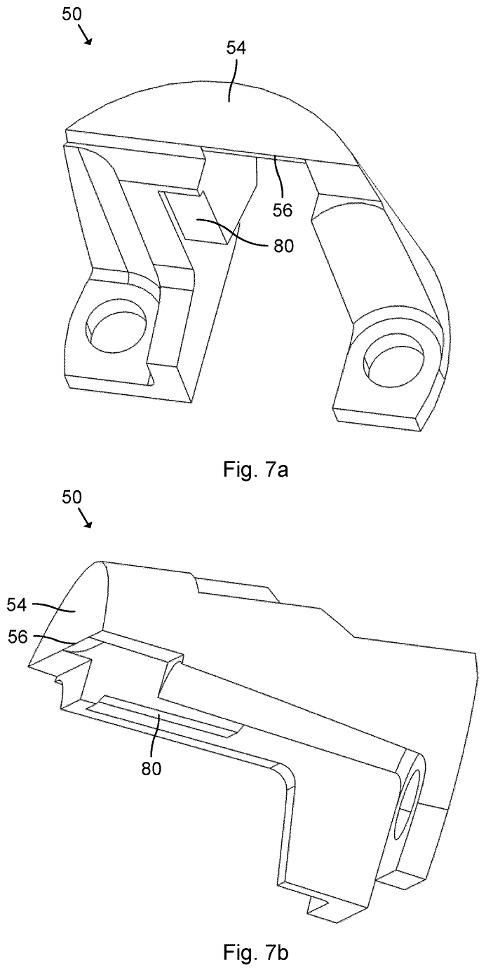

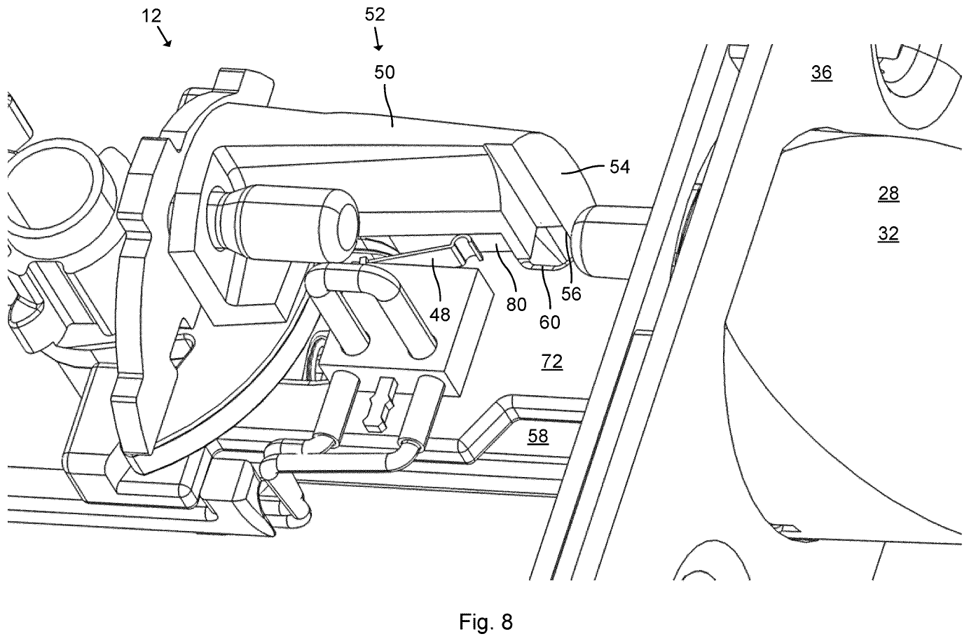

FIG. 7a schematically represents a perspective side view of the trigger member 50, and FIG. 7b schematically represents a perspective front view of the trigger member 50. In FIGS. 7a and 7b, the blocking trigger surface 54 and the trigger edge 56 can be seen more clearly. Moreover, the trigger member 50 of this example further comprises a switch triggering surface 80. The switch triggering surface 80 is arranged to contact and trigger the electrical switch 48 when the trigger member 50 adopts the activated position.

FIG. 8 schematically represents a partial perspective rear view of the lock device 12 in FIGS. 4a-4d. In FIG. 8, the electrical switch 48 and the interaction between the switch triggering surface 80 and the electrical switch 48 can be seen more clearly.

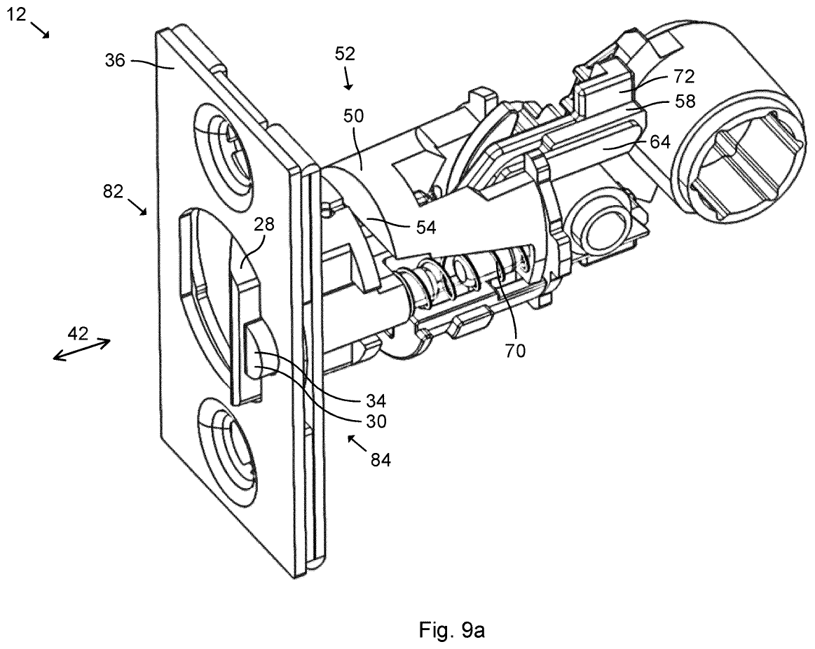

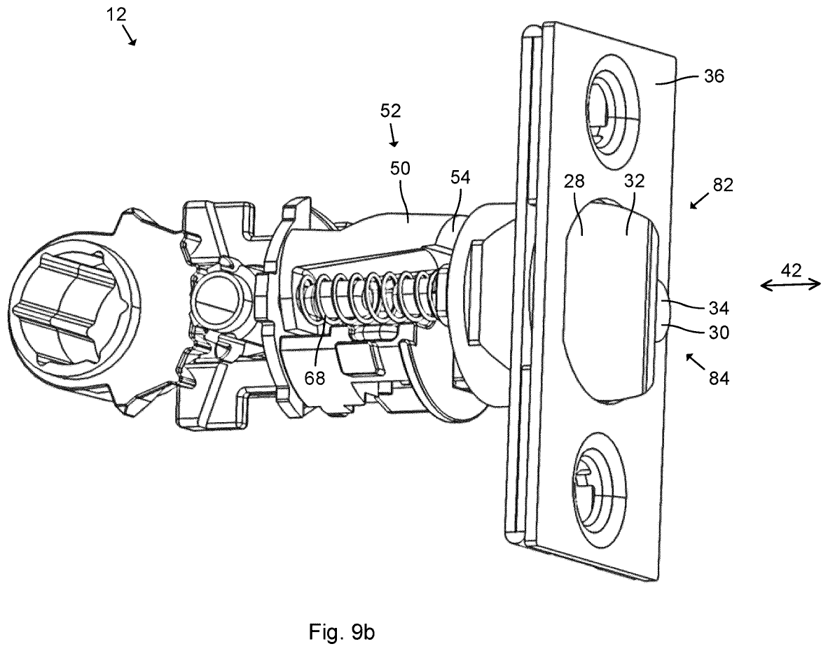

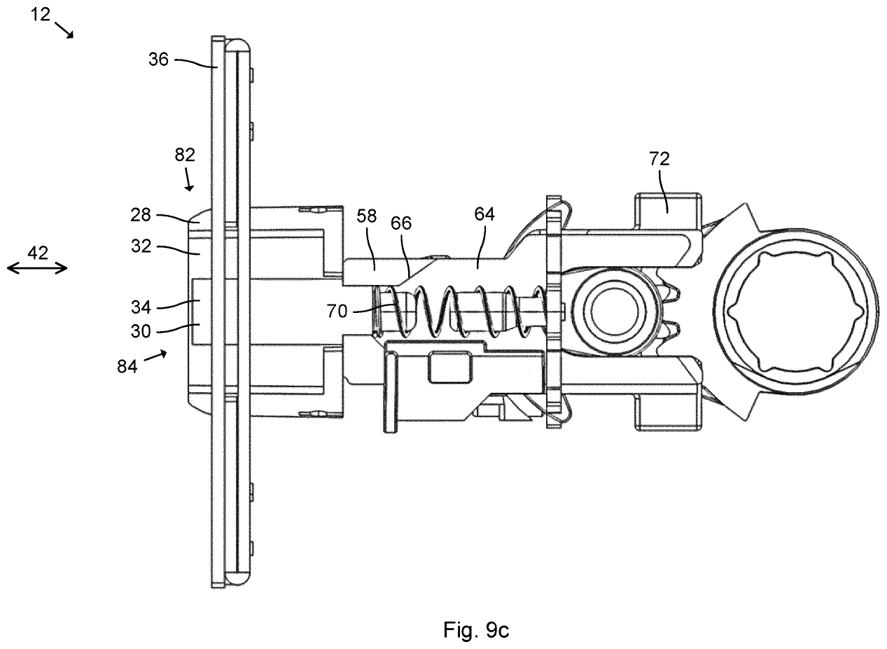

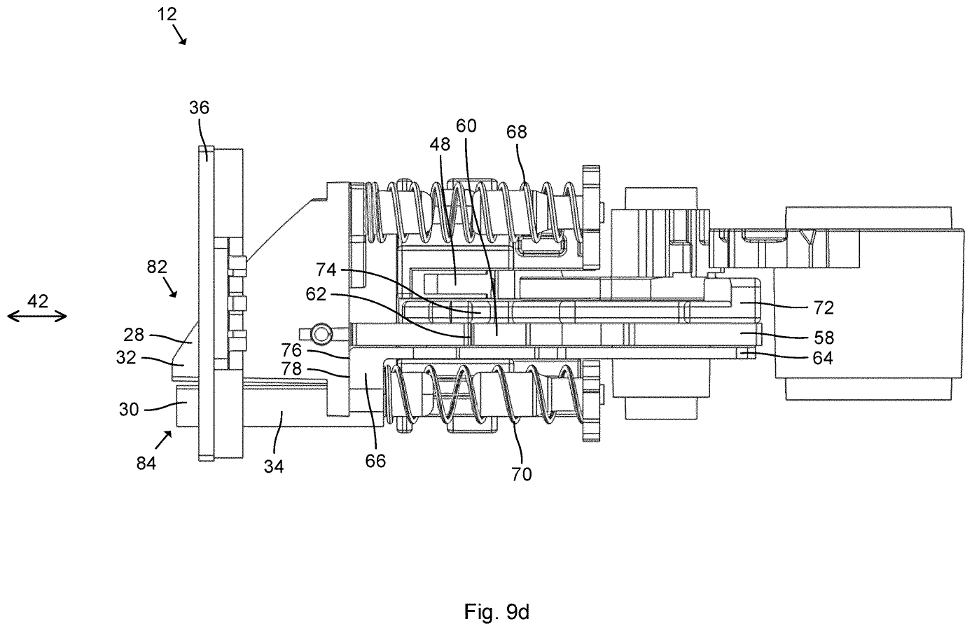

FIG. 9a schematically represents a partial perspective front view of the lock device 12 when the bolt 28 is in the retracted bolt position 82 and the auxiliary member 30 is in the retracted auxiliary position 84, FIG. 9b schematically represents a partial perspective rear view of the lock device 12 in FIG. 9a, FIG. 9c schematically represents a partial front view of the lock device 12 in FIGS. 9a and 9b, and FIG. 9d schematically represents a partial top view of the lock device 12 in FIGS. 9a-9c.

Except for the removal of the trigger member 50 in FIGS. 9c and 9d, FIGS. 9a-9d show views of the lock device 12 in the same state. Also in FIGS. 9a-9d, the trigger member 50 is in the deactivated position 52. Thus, the electrical switch 48 is not triggered in FIGS. 9a-9d.

The bolt 28 has been moved from the extended bolt position 44 to the retracted bolt position 82 against the compression of the bolt spring 68, for example by manual actuation of the handle 20. This movement of the bolt 28 has caused the auxiliary member 30 to move from the extended auxiliary position 46 to the retracted auxiliary position 84 against the compression of the auxiliary spring 70, here by interaction between the auxiliary member engaging surface 76 and the bolt engageable surface 78.

Since the bolt 28 is in the retracted bolt position 82 in FIGS. 9a-9d, the bolt structure 60 is not aligned with the trigger edge 56. The trigger edge 56 is thus positioned on top of (in this example) the bolt plate 58 without entering the bolt structure 60 when the bolt 28 is in the retracted bolt position 82. Thus, as shown in FIGS. 9a-9d, the bolt structure 60 is arranged to prevent the trigger member 50 from moving from the deactivated position 52 to the activated position when the bolt 28 adopts the retracted bolt position 82. Thus, also in the state in FIGS. 9a-9d, the trigger member 50 does not trigger the electrical switch 48.

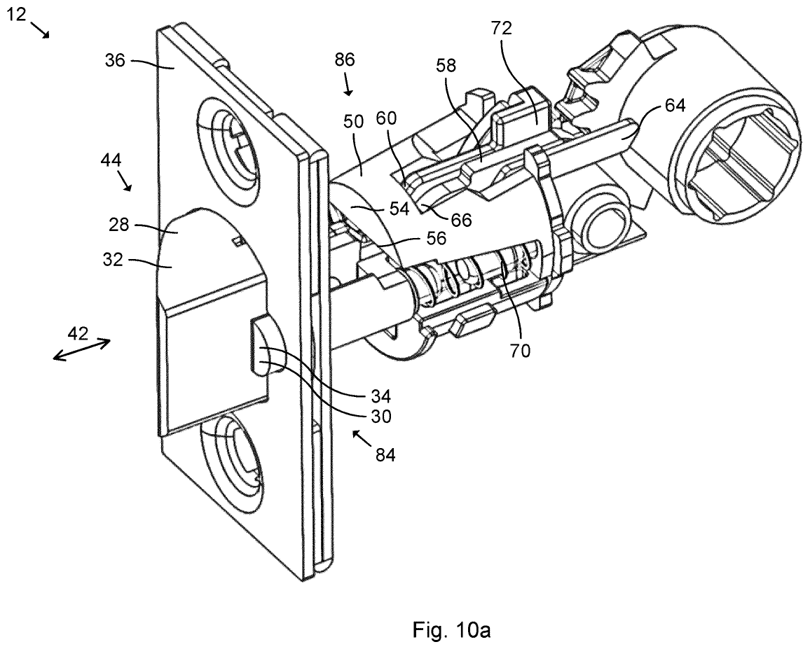

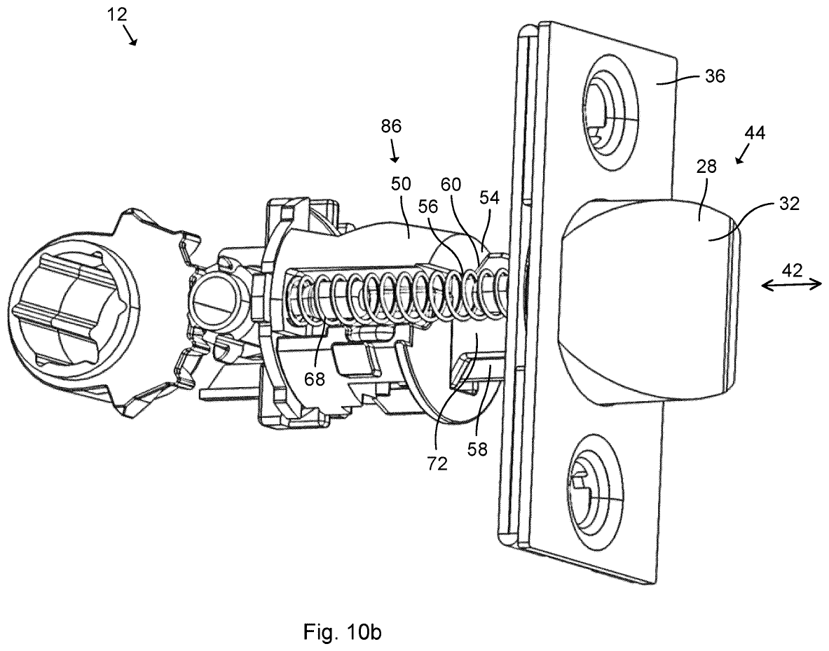

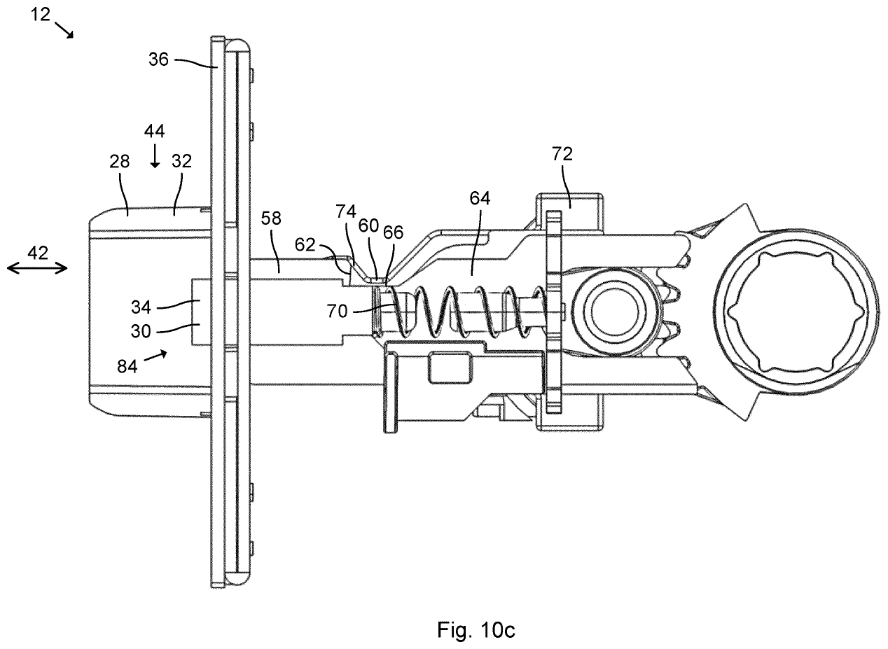

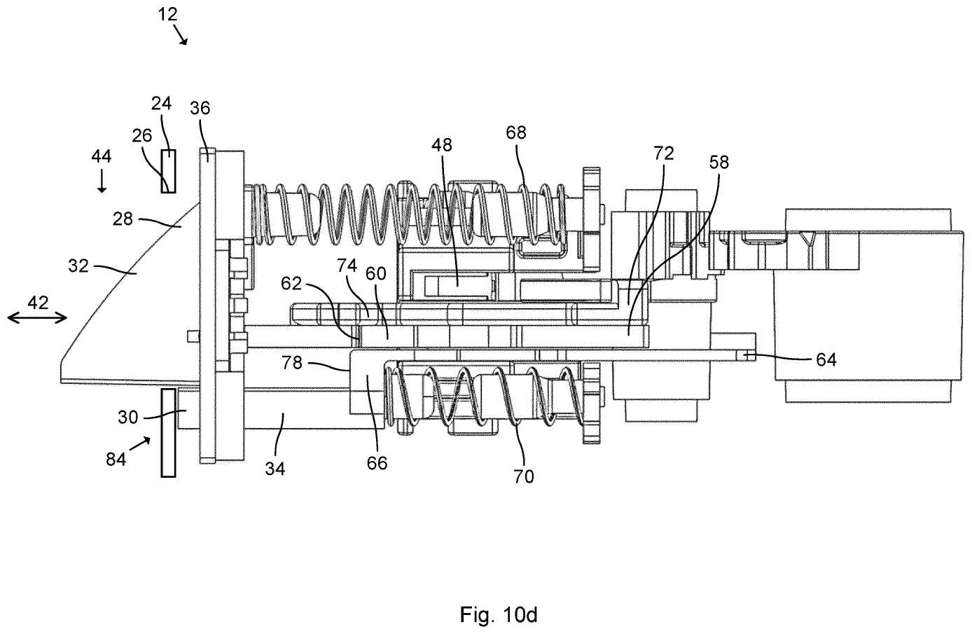

FIG. 10a schematically represents a partial perspective front view of the lock device 12 when the bolt 28 is in the extended bolt position 44 and the auxiliary member 30 is in the retracted auxiliary position 84, FIG. 10b schematically represents a partial perspective rear view of the lock device 12 in FIG. 10a, FIG. 10c schematically represents a partial front view of the lock device 12 in FIGS. 10a and 10b, and FIG. 10d schematically represents a partial top view of the lock device 12 in FIGS. 10a-10c. FIG. 10d also shows the relationships between the bolt 28, the auxiliary member 30 and the strike plate 24. Except for the removal of the trigger member 50 in FIGS. 10c and 10d and the illustration of the strike plate 24 in FIG. 10d, FIGS. 10a-10d show views of the lock device 12 in the same state.

When closing the door leaf 16, the bolt 28 will contact the strike plate 24 such that the bolt 28 moves from the extended bolt position 44 to the retracted bolt position 82. When the bolt 28 moves from the extended bolt position 44 to the retracted bolt position 82, the bolt 28 will engage the auxiliary member 30 and push the auxiliary member 30 from the extended auxiliary position 46 to the retracted auxiliary position 84, here by the engagement between the auxiliary member engaging surface 76 and the bolt engageable surface 78. During further closing of the door leaf 16, the bolt 28 will become aligned with the strike opening 26 and then be pushed by the bolt spring 68 from the retracted bolt position 82 to the extended bolt position 44 where the bolt 28 is received in the strike opening 26. When the door leaf 16 is closed and in the frame 14, such that the bolt 28 protrudes into the strike opening 26, the engagement between the strike plate 24 and the auxiliary member 30 will prevent the auxiliary member 30 from moving from the retracted auxiliary position 84 to the extended auxiliary position 46, as shown in FIG. 10d. Thus, since the door leaf 16 is closed and in the frame 14, the auxiliary member 30 is depressed and held in the retracted auxiliary position 84 by engaging the strike plate 24 outside the strike opening 26.

Since the bolt 28 is in the extended bolt position 44 and the auxiliary member 30 is in the retracted auxiliary position 84 in FIGS. 10a-10d, both the bolt structure 60 and the auxiliary structure 66 are aligned with the trigger edge 56 along the movement direction 42. The bolt structure 60 and the auxiliary structure 66 are thus aligned to create room for the trigger member 50, here such that the trigger edge 56 can move into each of the bolt structure 60 and the auxiliary structure 66. The bolt spring 68 and the auxiliary spring 70 now force the trigger member 50 to move from the deactivated position 52 to the activated position 86. In the activated position 86, the trigger edge 56 is received in the bolt structure 60 and the auxiliary structure 66. The switch triggering surface 80 now contacts and triggers the electrical switch 48. The electrical switch 48 may output an electrical signal indicative of the triggering. The electrical signal may for example be sent as feedback to a control system of the lock device 12, to a customer and/or to an external monitoring system.

The electrical switch 48 is thus only triggered when the bolt 28 adopts the extended bolt position 44 and the auxiliary member 30 adopts the retracted auxiliary position 84. Also in the activated position 86, the trigger edge 56 is oriented transverse to the movement direction 42.

In the activated position 86, the blocking trigger surface 54 is oriented transverse to the movement direction 42. Therefore, when the trigger member 50 is in the activated position 86, the engagement between the blocking trigger surface 54 and the blocking bolt surface 62 prevents the bolt 28 from being fraudulently forced from the extended bolt position 44 to the retracted bolt position 82 by adding a force on the bolt head 32, e.g. by a credit card. When the trigger member 50 moves from the deactivated position 52 to the activated position 86, the trigger member 50 both triggers the electrical switch 48 and blocks retraction of the bolt 28 from the extended bolt position 44 to the retracted bolt position 82.

In this example, rotation of the handle 20 and the follower 40 will cause retraction of the bolt retractor 72. Retraction of the bolt retractor 72 will in turn cause the detrigger surface 74 to function as a cam surface to lift the trigger edge 56. The trigger member 50 will thereby move back from the activated position 86 to the deactivated position 52 against the forces from the bolt spring 68 and the auxiliary spring 70. Retraction of the bolt retractor 72 will also pull the bolt 28 to move from the extended bolt position 44 to the retracted bolt position 82 to be disengaged from the strike opening 26.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1-15. (canceled)

16. A lock device for installation in an access member, the lock device comprising:
a base structure;
a bolt movable relative to the base structure between an extended bolt position for engagement with a strike opening of a strike and a retracted bolt position for disengagement from the strike opening, the bolt having a bolt structure;
an auxiliary member movable relative to the base structure between an extended auxiliary position and a retracted auxiliary position for engagement with a strike plate of the strike, the auxiliary member having an auxiliary structure;
a sensor; and
a trigger member movable between a deactivated position where the trigger member does not cause activation of the sensor, and an activated position where the trigger member causes activation of the sensor, the trigger member being forced towards the activated position;
wherein the bolt structure and the auxiliary structure are arranged to allow the trigger member to move from the deactivated position to the activated position when the bolt adopts the extended bolt position and the auxiliary member adopts the retracted auxiliary position;
wherein the bolt structure is arranged to prevent the trigger member from moving from the deactivated position to the activated position when the bolt adopts the retracted bolt position; and
wherein the auxiliary structure is arranged to prevent the trigger member from moving from the deactivated position to the activated position when the auxiliary member adopts the extended auxiliary position.

17. The lock device according to claim 16, wherein the trigger member and the bolt structure are arranged to cooperate to prevent movement of the bolt from the extended bolt position to the retracted bolt position when the trigger member is in the activated position.

18. The lock device according to claim 17, wherein the bolt structure comprises a blocking bolt surface substantially transverse to a movement direction of the bolt for being engaged by the trigger member in the activated position to prevent movement of the bolt from the extended bolt position to the retracted bolt position.

19. The lock device according to claim 18, wherein the trigger member comprises a blocking trigger surface oriented substantially transverse to the movement direction and arranged to be engaged by the blocking bolt surface when the trigger member adopts the activated position.

20. The lock device according to claim 16, wherein the bolt comprises a bolt plate including the bolt structure, wherein the auxiliary member comprises an auxiliary plate including the auxiliary structure, and wherein the auxiliary plate is substantially parallel with the bolt plate.

21. The lock device according to claim 20, wherein the bolt plate and the auxiliary plate are parallel with a movement direction of the bolt.

22. The lock device according to claim 16, wherein the trigger member is pivotable between the deactivated position and the activated position.

23. The lock device according to claim 16, wherein the lock device comprises a bolt retractor arranged to be driven by manual actuation of an actuation member and arranged such that movement of the bolt retractor causes the bolt to move from the extended bolt position to the retracted bolt position, wherein the bolt retractor comprises a detrigger surface arranged to transmit a movement of the bolt retractor to a movement of the trigger member from the activated position to the deactivated position.

24. The lock device according to claim 23, wherein the trigger member comprises a trigger edge arranged to cooperate with the bolt structure, the auxiliary structure, and the detrigger surface.

25. The lock device according to claim 16, wherein the auxiliary member is movable relative to the base structure in parallel with movements of the bolt between the extended bolt position and the retracted bolt position.

26. The lock device according to claim 16, wherein the base structure comprises a forend.

27. The lock device according to claim 26, wherein the bolt and the auxiliary member protrude from the base structure in the extended bolt position and in the extended auxiliary position, respectively.

28. The lock device according to claim 16, wherein the trigger member is arranged to contact the sensor in the activated position.

29. The lock device according to claim 16, further comprising at least one spring arranged to force the trigger member towards the activated position.

30. The lock device according to claim 29, wherein the at least one spring comprises at least one of a bolt spring, arranged to force the bolt from the retracted bolt position to the extended bolt position, or an auxiliary spring, arranged to force the auxiliary member from the retracted auxiliary position to the extended auxiliary position.

31. The lock device according to claim 16, wherein the bolt and the auxiliary member are configured such the auxiliary member is forced by the bolt from the extended auxiliary position to the retracted auxiliary position by movement of the bolt from the extended bolt position to the retracted bolt position.

32. A system comprising a lock device according to claim 16, a frame including the strike, and the access member movable relative to the frame, wherein the lock device is installed in the access member.
